(19) United States
(12) Patent Application Publication
(10) Pub. No.: US 2003/0113497 A1
(43) Pub. Date: Jun. 19, 2003

(54) Polymeric sleeve used in printing blanket

(76) Inventors: Ronald M. Buono, Flat Rock, NC (US); Joseph Carl Kalchbrenner, Greer, SC (US)

Correspondence Address: PENNIE & EDMONDS LLP, 1667 K STREET NW, SUITE 1000, WASHINGTON, DC, 20006

(21) Appl. No.: 10/101,186

(22) Filed: Mar. 20, 2002

Related U.S. Application Data
(60) Provisional application No. 60/303,804, filed on Jul. 10, 2001.

(51) Int. Cl. B32B 1/08

(52) U.S. Cl. 428/36.91

(57) ABSTRACT

The present invention relates to a printing blanket comprising an inner multilayer spiral wound polymeric sleeve, wherein the sleeve comprises between 2 and 5 layers that are affixed to one another with an adhesive, the winds overlay one another to form the multiple layers, the gap between adjacent edges of each ribbon are less than 0.2 inches apart as measured axially, the total sleeve thickness is between 0.006 to 0.0028 inches, and the layers are formed either from a single continuous ribbon or a plurality of continuous ribbons of polymeric material. The adjacent edges of the ribbon may alternately overlay axially in an amount such that relaxation during curing results in non-overlapping edges.

### CROSS-REFERENCE TO RELATED APPLICATION

This application claims priority to U.S. Provisional Patent Application No. 60/303,804, filed Jul. 10, 2001, the entire disclosure of which is hereby incorporated by express reference hereto.

### FIELD OF THE INVENTION

The present invention relates to a replaceable sleeve which may be readily mounted onto a cylindrical carrier, for example a replaceable sleeve comprising a multilayer reinforced composite. More particularly, this invention relates to a polymeric inner sleeve for use with seamless and gapless off-set printing blankets, and with gapped off-set printing blankets.

### BACKGROUND OF THE INVENTION

Rubber-covered cylindrical rollers are widely used in industry for a number of applications, particularly for web or sheet handling and processing applications such as the embossing, calendering, laminating, printing and coating of paper, film, foil, and other materials. In addition to their use in web processing equipment, such rubber-covered rollers are often employed in conveyors and various office machines. Such rollers are typically comprised of a cylindrical (metal) core or other support with an outer covering of rubber, elastomer, or polymer material. However, after extended use, the covering on the rollers wears down and must be resurfaced or replaced. This typically requires that the rollers be sent to an outside source where the old surface is ground down and a new surface is applied. This is inconvenient and expensive as it requires that the processing equipment be shut down while the roller is being resurfaced or that the end user stock additional replacement rollers.

Cylindrical rollers are widely used in the printing industry. For example, printing rollers or sleeves are used in the flexographic printing industry and in the offset printing industry for providing a mountable surface for flexographic printing plates or offset printing blankets. In a typical flexographic printing press, the sleeve is mounted onto a printing cylinder using pressurized air to expand the sleeve, and the printing plates are then attached to the outer surface of the sleeve. In an offset printing process, the blanket is mounted onto a printing cylinder using pressurized air to expand the blanket.

Typically in blankets, high to medium levels of fillers and blends of fillers have been used. Typically these are low to non-reinforcing in nature. The rubber composition typically comprises polysulfide rubber. For cure systems, conventional systems are used as defined in “The Vanderbilt Rubber Handbook”. Typically the over all recipes resemble the recipes, which can be found in the section on Sponge Rubber found in “The Vanderbilts Rubber Handbook”, medium to highly loaded with non-reinforcing fillers and conventional cure systems. Such rubber compositions have poor wearability and strength.

The introduction of the Sunday Press by Heidelberg M-3000™ has challenged the printing face prior art by providing operational conditions, which exist outside the experience envelop of the printing face chemistry used on the traditional Flat Blankets. The higher web speeds and the thinner blanket design have challenged the performance of the traditional formulary chemistry used as printing faces on blankets.

The prior art for preparing a compressible layer for a printing blanket, as discussed in U.S. Pat. No. 5,553,541, utilizes a thin nickel sleeve, and for the compressible layer threads as a carrier for the rubber composition and the entrapped microcells. Microspheres from are available commercially from EXPANCEL Inc., an AKZO NOBEL Co., Duluth, Ga. USA. The thickness of the compressible layer is determined by the coating of threads of different thicknesses. The threads act as a carrier for the compressible microcellular rubber formulation, and form a partially inelastic layer of different physical characteristics than the remaining portion of the layers in the blanket. The threads are wound under tension, and the deposited layer typically stratifies to a thread-rich inner portion and a thread-poor outer portion. The use of threads is expensive and time consuming. Additionally, the presence of threads close below the face layer of the printing blanket may cause print imperfections due to a variation in pressure points. The apex of the threads applies more pressure to the printed surface then the area where two threads meet and adjoin each other.

While not used commercially, U.S. Pat. No. 5,323,702 describes applying a compressible layer by metering with a doctor roll, a doctor blade, or by conventional spraying.

Typically thin metal inner sleeves are used for their a high modulus/low elongation properties. The commercial sleeves are exclusively a thin 0.003″ to 0.010″ nickel alloy.

Other sleeves have been developed which comprise polymeric materials. For example, U.S. Pat. No. 5,440,981 describes the nickel sleeve, and then states the sleeve can be a polymeric material such as fiberglass or mylar having a thickness of 0.030 inches. U.S. Pat. No. 5,860,360 describes printing sleeves which include laminated polymeric layers reinforced with woven or non-woven fabric layers. Such sleeves provide an advantage over metal in that they are readily expandable for mounting and are seamless and provide good structural integrity for printing operations without the damage and safety limitations of thin metal sleeves.

However such thread wound or fabric reinforced polymeric sleeves are typically expensive to manufacture and slow to fabricate. Further, the presence of fibers or threads in any layer is believed to result in deformations where threads overlap, thereby adversely affecting printing quality. Finally, a 0.030 inch thickness is too great to be used in modern printing blankets, for example the HEIDELBER M-3000 SUNDAY PRESS™.

Further, many polymeric printing sleeves in use require specific polymers and/or cure temperatures, which restricts the choice of materials or properties of the finished blanket.

What is needed is polymeric sleeves which overcome these obstacles.

### SUMMARY OF THE INVENTION

An inner sleeve is disclosed for use in a cylindrical printing blanket comprising a multilayer spiral wound polymeric sleeve, wherein the sleeve comprises between 2 and 5 layers that are affixed to one another with an adhesive, the winds overlay one another to form the multiple layers, the gap between adjacent edges of the ribbon are less than 0.2 inches apart as measured axially, the total sleeve thickness is between 0.006 to 0.0028 inches, and the layers are formed from a single continuous ribbon of polymeric material.

### DETAILED DESCRIPTION OF THE PREFERRED EMBODIMENTS

The present invention is related to several other co-pending applications, namely U.S. Patent Application No. ______ , entitled “Printing Face Formulary,” filed on even date herewith and itself claiming priority to U.S. Provisional Patent Application No. 60/303,767, filed Jul. 10, 2001; U.S. Patent Application No. ______, entitled “Printing Blanket Face and Compressible Layer Compositions,” filed on even date herewith and itself claiming priority to U.S. Provisional Patent Application No. 60/303,818, filed Jul. 10, 2001; and U.S. Patent Application No. ______, entitled “Spray Coating Method of Producing Printing Blankets,” filed on even date herewith and itself claiming priority to U.S. Provisional Patent Application No. 60/303,803, filed Jul. 10, 2001, each of the entire disclosures of which are hereby incorporated herein by express reference hereto.

The invention relates to forming a printing blanket by providing an inner sleeve, priming the sleeve, and applying on the primed sleeve a compressible layer and/or a reinforcing layer, and a printing face layer. The invention more particularly relates to a polymeric inner sleeve that forms an inner layer of the offset printing blanket.

One aspect of the invention is a multilayer spiral wound polymeric sleeve, wherein the winds lay so that the gap between adjacent (but separated by a layer of the sleeve) ends of the ribbon are less than 0.2 inches, preferably less than about 0.1 inches, more preferably less than about 0.05 inches. The sleeve comprises a plurality of layers, for example between 2-5 layers, pref. 2-3 layers. Advantageously, these layers are formed from a single continuous ribbon of polymeric material.

The total sleeve thickness is between 0.006 to 0.0028 inches, preferably between about 0.009 to about 0.024 inches, even more preferably between about 0.015 to about 0.021 inches. This individual layers are about one half for a two-layer sleeve, or one third for a three layer sleeve, of the total thickness.

The polymeric sleeve can be comprised of any thermoplastic or thermoset polymer with high tensile strength, for example ARAMID™, polyester, high density linear polyethylene, MYLAR, or other film making polymer, which typically has a high modulus/low elongation properties. A preferred sleeve is formed of two layers of MYLAR.

In another embodiment of the invention, the multilayer spiral wound sleeve is comprised of multiple ribbons of material. In this case the adjacent edges of the ribbon advantageously abut one another, and the edges are axially displaced from one another such that no two layers have overlying edges. In this case the sleeve can contain two or more materials, for example an ARAMID™ layer and a MYLAR layer.

Typically fabrication of such sleeves is a low cost process which is an advantage over the existing art for the Off-Set printing industry.

Another aspect of the invention relates to an adhesive to bond the laminated layers together. This adhesive also requires specific polymers and/or cure temperatures, which restricts the choice of materials or properties in the final sleeve. A polyethylene terephthalate adhesive for sleeves exist for flexographic printing, however the adhesive used melts at too low at temperature for it to be reliable for the offset printing blanket applications.

One aspect of the invention is a thermoplastic adhesive with a melt temperature greater than about 300° F. The higher melt adhesive holds the sleeve in place during the final product curing temperature. One adhesive includes a carboxylated butadiene acrylonitrile. The adhesive gum may contain a small amount of cross linking agents.

In another embodiment a thermoset adhesive, for example a two-component urethane adhesive. Polyurethanes, which are formed by the reaction of the hydroxyl groups of a polyol with a curing agent such as an organic isocyanate compound, provide excellent bonding or joining properties when cured, thus forming strong adhesives. By utilizing an isocyanate terminated prepolymer technique, it is possible to obtain moisture curable formulations which provide similar adhesive properties. High green strength polyurethanes, such as those described in U.S. Pat. Nos. 4,889,915 and 5,036,143, the disclosures of which are incorporated herein by reference, are suitable for use in the instant application. High green strength adhesives tend to prevent wrinkling and slippage of films during lamination. In one embodiment, the curing agent comprises a primary or secondary alkyl amine, preferably a primary alkyl diamine or alkyl tri-amine. In another embodiment, the curing agent comprises a primary or secondary ether amine or alkyl ether amine. In another embodiment, the curing agent comprises a polyetheramine, for example a poly(oxypropylene)amine.

In another embodiment, the spirally wound sleeve is fabricated with a slight overlap of adjacent layers, and normal thermoplastic adhesives are used. This overlap is predetermined to slip into a butt seam, that is, no overlapping, upon vulcanization of the final blanket, as relaxation of the spiral coil due to an interference fit of the sleeve on the curing mandrel.

In another embodiment, this invention relates to a pre-made compressible layer/cushion layer affixed to the spiral wound polymeric sleeve. The pre-made compressible or cushion layer functions to provide energy absorption and resiliency to the blanket while allowing strain deformations to occur in the radial direction with little to no Poisson's effect occurring at the printing interface to kept the printing within the required specs. The compressible layer may comprise of an open or closed-cell polymeric foam. The cell structure of the foam, may be created with suitable chemical blowing agents such as magnesium sulfate, hydrated salts, hydrazides such as p-toluene sulfonyl hydrazide and p,p-oxybisbenzene sulfonyl hydrazide, and carbonamides such as 1,1′-azobisformamide, nitrate, nitrite, bicarbonate and carbonate salts. Still another preferred method of forming the compressible layer includes the incorporation of microcapsules. The preferred embodiment contains unexpanded microspheres from EXPANCEL™ where the microspheres are added to the elastomeric material via for example mill mixing.

The process of spirally forming the polymeric sleeve involves placing an adhesive on the ribbon, and then spirally winding the ribbon. This process is amenable to additionally affixing a thin spirally wound polymeric, i.e., foam or solid, to the sleeve. The elastomer in this compressible layer selected from but not limited to consisting of a nitrile-butadiene copolymer, hydrogenated nitrile-butadiene copolymer, carboxylated nitrile-butadiene copolymer, nitrile-butadiene-isoprene terpolymers, neoprene, isoprene, epoxidized isoprene, SBR, EPDM, butyl, halogenated butyl, fluoroelastomers, or any of the polyurethane elastomeric rubbers, or blends of such.

One embodiment includes a polyurethane foam which has a cell density of from 5 to 60 pounds/cubic foot, preferred 10 to 45, and more preferred 20 to 40 pounds/cubic foot. This cushion layer is spiral wound with the polymeric sleeve, wherein the winds lay so that the gap between adjacent ends are less than 0.2 inches, preferably less than about 0.1 inches, more preferably less than about 0.05 inches. Another aspect, a spiral wound strip may consist of a winding, which may have a gap, a butt seam, or an overlap seam, at any spiral angle from <90 degrees perpendicular to >0 degrees from the surface.

Advantageously, the gapped seam of this preformed cushion layer is subsequently filled, for example during final fabrication. It was found that this gap could be filled with an elastomer consisting of a nitrile-butadiene copolymer, hydrogenated nitrile-butadiene copolymer, carboxylated nitrile-butadiene copolymer, nitrile-butadiene-isoprene terpolymers, neoprene, isoprene, epoxidized isoprene, SBR, EPDM, butyl, halogenated butyl, fluoroelastomers, or any of the polyurethane elastomeric rubbers, or blends of such, which incorporated microcells or blowing agents. The compressible layer may comprise of an open or closed-cell polymeric foam. The cell structure of the foam, may be created with suitable chemical blowing agents such as magnesium sulfate, hydrated salts, hydrazides such as p-toluene sulfonyl hydrazide and p,p-oxybisbenzene sulfonyl hydrazide, and carbonamides such as 1,1′-azobisformamide, nitrate, nitrite, bicarbonate and carbonate salts. A preferred method of forming the compressible layer includes the incorporation of microcapsules.

To fill the gap, the compressible or cushion material is solvated to allow it to flow into the thin gap with little deformation of the pre-made cushion layer. The compressible material may be forced into the gap by, for example, spray, flowcoat, doctor blade, or thread entrapment and winding. Upon curing, the gap is sealed. The foam is set via low temperature curatives such as Butyl Eight as recommended by “The Vanderbilts Rubber Handbook” or by other means for low temperature polymeric crosslinking. The advantage of this embodiment is speed of fabrication and low cost or most other known fabrication methods. The advantage is also in the continuous operation of winding the sleeve. This sleeve can then be used in a blanket that contains thread or a no-thread blanket for the Off-Set Printing Industry.

According to one aspect of the present invention, a replaceable blanket is provided which is adapted to be mounted on a carrier. By carrier, we mean any structure which functions to support the sleeve during use and allows it to rotate during use including but not limited to cylinders, tubes, and liners. The replaceable blanket is made up of a combination of layers including an inner sleeve, optionally a reinforcing layer overlying the inner sleeve, an intermediate compressible polymeric layer overlying sleeve/reinforcing layer, optionally a reinforcing layer overlying the compressible layer, and an outer polymeric layer forming a working, i.e., printing, surface.

One aspect of the invention involves adding a layer or strip to control friction on the interior of the inner sleeve. A polymeric sleeve will have a different coefficient of friction than the nickel sleeves of the prior art, and friction modifiers may be advantageously incorporated into the polymeric sleeve or on the inner surface of the polymeric sleeve. The sleeve may have a coating or layer on the internal diameter to provide the desired friction or holding strength to the roller.

In one embodiment, this compressible layer comprises a composition formed from a nitrile-butadiene copolymer, hydrogenated nitrile-butadiene copolymer, carboxylated nitrile-butadiene copolymer, nitrile-butadiene-isoprene terpolymers, neoprene, isoprene, epoxidized isoprene, SBR, or any of the polyurethane elastomeric rubbers, or blends of such. The cell structure of the compressible layer may be created with suitable chemical blowing agents such as magnesium sulfate, hydrated salts, hydrazides such as p-toluene sulfonyl hydrazide and p,p-oxybisbenzene sulfonyl hydrazide, and carbonamides such as 1,1′-azobisformamide, nitrate, nitrite, bicarbonate and carbonate salts. Still another preferred method of forming the compressible layer includes the incorporation of microcapsules, for example microcells.

In one embodiment a thin nickel sleeve is overlain by the polymeric sleeve of the current invention, thereby forming a sleeve with greater strength and durability than the nickel sleeve.

The one or more elastomeric rubbers useful in the present invention can include, but are not limited to: natural rubber, polyisoprene rubbers, polyisobutylene rubbers, polybutadiene rubbers, chloroprene rubbers (e.g., such as those commercially available under the tradename NEOPRENE from DuPont Chemical), nitrile rubbers (e.g., such as acrylonitrile-butadiene copolymers, or NBRs, commercially available under the tradename NIPOL from Zeon Chemicals Inc. or under the tradename PARACRIL from Uniroyal), butyl rubbers, silicone rubbers, fluorinated rubbers (e.g., such as those commercially available under the tradename VITON from DuPont Chemical), polysulfides (e.g., such as those commercially available under the tradename THIOKOL from Rohm & Haas), copolymer rubbers (e.g., random, alternating, block, multiblock, graft, multigraft, comb, star, branched, and/or dendritic copolymers comprising at least one of ethylene, propylene, butadiene, isoprene, styrene, isobutylene, and the like, fully or partially hydrogenated versions thereof, or a combination thereof, which may include, but are not limited to, EPDM, EPR, SBR, SBS, SIS, SEBS, SEPS, SEEPS, or combinations thereof), and the like, as well as mixtures or copolymers thereof. In one preferred embodiment, the one or more elastomeric rubbers comprises a nitrile rubber. In another preferred embodiment, the one or more elastomeric rubbers consists essentially of one or more nitrile rubbers.

The one or more additives and/or processing aids useful in the invention may include, but are not limited to:

organic or inorganic low molecular weight fillers and/or reinforcing agents (e.g., clay; talc; glass fibers; mica; calcium metasilicate; barium sulfate; zinc sulfide; lithopone; silicates; silicon carbide; diatomaceous earth; carbonates such as calcium carbonate and magnesium carbonate; silica such as that commercially available under the tradename HISIL from PPG Industries; particulate carbonaceous materials such as graphite, carbon black (e.g., commercially available from Cabot), cotton flock, natural bitumen, and cellulose flock; micro balloons such as glass and ceramic; fly ash; or the like; or combinations thereof), preferably silica and/or carbon black, more preferably, where carbon black is used, a mixture of grades may be used, but preferably a single grade of carbon black is used, more preferably the Cabot N550 grade of carbon black;

tackifying additives (e.g., wood resins, such as coumarone-indene or lignin resin, and/or those commercially available under the tradename FF from Hercules);

phenol-formaldehyde resins, such as those commercially available under the tradename P-87 from Akrochem; and the like, or combinations thereof);

homogenization agents (e.g., plasticizing organic oils, such as those aromatic oils commercially available under the tradename SUNDEX from Sun, di(butoxy-ethoxy-ethyl) formal, which is available under the tradename TP-90B from Rohm & Haas, or the like, or a mixture thereof;

oligomeric/polymeric oils, such as polyester phthalate, which is available commercially under the tradename PLASTHALL from CP Hall, mixed phthalate oils, such as those commercially available under the tradename PALANTIOL from BASF, or the like, or a mixture thereof; or the like; or a combination thereof);

formability enhancers (e.g., factices or vulcanized oils, such as crosslinked vegetable oil, which can be obtained commercially under the tradename RHENOPRENE from Bayer);

reaction controlling compounds (e.g., retarding agents, such as those commercially available under the tradename PVI from Vanderbilt);

pigments (e.g., white pigments, such as (rutile) titania which is commercially available from DuPont or, in combination with nitrile rubber, from Polymerics; blue pigments, such as 12973 Blue, which is commercially available from Harwick; and the like; or combinations thereof);

surface active compounds (e.g., silane compounds, such as organosilanes commercially available, inter alia, from Degussa);

and the like; or a mixture thereof.

The crosslinking agent according to the invention may include one or more compounds that facilitate the crosslinking/vulcanization of the elastomeric rubber component and may advantageously include, but is not limited to:

accelerators (for example, organic sulfur-containing compounds, such as sulfenamides, e.g., mercapto-benzothiazole sulfenamide or N-tert-butylbenzothiazole sulfenamide, which are both commercially available, in combination with EPR, under the tradename RHENOGRAN from Rhein Chemie; tetraethylthiuram, which is commercially available under the tradename TETD from Akrochem; tetramethylthiuram, which is commercially available under the tradename TMTD from Akrochem; carbamide compounds, such as those commercially available under the tradename BUTYL-8; dithiodimorpholine, which is commercially available under the tradename VANAX from Vanderbilt; or the like; or a combination thereof);

activators (e.g., zinc oxide, which is commercially available, in combination with EPR, under the tradename RHENOGRAN from Kenrich; magnesium oxide, which is commercially available under the tradename MAGLITE from CP Hall and which is also useful to alter the hydrophilicity of the composition; polyethylene glycol, such as that commercially available under the tradename CARBOWAX from Union Carbide, and which is also useful to alter the hydrophilicity of the composition; or the like; or combinations thereof);

sulfur compounds (e.g., elemental sulfur or other sulfur source, such as P-80, which is commercially available from Akrochem, in combination with SBR; SPIDER SULFUR, which is commercially available from Akrochem; or the like; or a combination thereof);

acidic dispersants (e.g., organic fatty acids having a number average molecular weight below about 500, such as stearic acid or the like);

or the like; or a combination thereof.

The one or more antioxidants may include, but are not limited to, one or more of the following, or combinations thereof:

(i) Phenol and/or alkylated monophenols;

(ii) Hydroquinones and/or alkylated hydroquinones;

(iii) Tocopherols;

(iv) Hydroxylated thiodiphenyl ethers;

(v) Bisphenol and/or alkylidenebisphenols;

(vii) O-, —and S-benzyl compounds;

(vii) Hydroxybenzylate malonates;

(viii) Aromatic hydroxybenzyl compounds;

(ix) Triazine compounds;

(x) Benzylphosphonates;

(xi) Acylaminophenols;

(xii) Ascorbic acid (Vitamin C);

(xiii) Aminic antioxidants such as hydroquinoline; phenylenediamine; and/or derivatives or mixtures thereof;

(xiv) UV-absorbers and light stabilizers;

(xv) Phosphites and phosphonites;

(xvi) Hydroxylamines;

(xvii) Thiosynergists such as dilauryl thiodipropionate, distearyl thiodipropionate, and mixtures thereof;

(xviii) Peroxide scavengers such as esters of thiodipropionic acid, for example the lauryl, stearyl, myristyl or tridecyl esters; mercaptobenzimidazole or the zinc salt of 2-mercaptobenzimidazole; zinc 2-mercapto-toluimidazole; zinc dibutyldithiocarbamate; dioctadecyl disulfide; pentaerythritol tetrakis(-dodecylmercapto)propionate; and mixtures thereof;

or mixtures thereof.

In a preferred embodiment, the at least one antioxidant is selected from the group consisting of zinc 2-mercapto-toluimidazole, bis-phenol, phenol, phenylenediamine, hydroquinoline, and any combination thereof.

Printing blankets according to the invention may advantageously contain a printing sleeve, a compressible layer, optionally a reinforcing layer, optionally an adhesive layer, and a printing face layer.

The compressible layer composition according to the invention may advantageously include about 100 parts of one or more elastomeric rubbers; one or more additives and/or processing aids; a crosslinking agent; and one or more antioxidants.

In a preferred embodiment, the one or more compressible layer elastomeric rubbers comprises at least one nitrile rubber, preferably at least one nitrile rubber copolymer having an acrylonitrile content from about 25% to about 41%, more preferably from about 30% to about 40%, most preferably from about 33% to about 37%. In this preferred embodiment, the at least one compressible layer nitrile rubber copolymer possesses an average acrylonitrile content from about 33% to about 40%, preferably from about 33% to about 37%. In a more preferred embodiment, the one or more compressible layer elastomeric rubbers comprises a terpolymer made from acrylonitrile and butadiene monomers, and preferably also containing isoprene monomers. Preferred terpolymers contain at least about 25%, more preferably at least about 30%, of each of the monomer components. More preferably, the terpolymer comprises acrylonitrile in an amount from about 33% to about 40%, butadiene in an amount from about 30% to about 40%, and another monomer component, preferably isoprene, in an amount from about 30% to about 40%. The compressible layer elastomeric rubber may contain a mixture of rubber homopolymers or copolymers containing acrylonitrile monomers, and preferably contains at least about 50%, more preferably at least about 80%, most preferably at least about 90%, of the acrylonitrile-butadiene-isoprene terpolymer.

In addition to about 100 parts rubber, a compressible layer composition according to the present invention may preferably comprise: microspheres present in an amount from about 1 to about 10 pph rubber; crosslinking agents present in an amount from about 5 to about 35 pph rubber, preferably from about 8 to about 25 pph rubber, more preferably from about 10 to about 20 pph rubber; one or more antioxidants present in an amount not more than about 15 pph rubber, preferably from about 0.5 to about 10 pph rubber, more preferably from about 1 to about 8 pph rubber; and additives and/or processing aids present in an amount not more than about 90 pph rubber, preferably from about 15 to about 85 pph rubber, more preferably from about 25 to about 75 pph rubber, most preferably from about 30 to about 70 pph rubber.

In preferred embodiments, a compressible layer composition according to the present invention may possess one or more of the following: a carbon black content from about 12 to about 28 pph rubber; a microsphere content from about 1 to about 10 pph rubber; a retarding agent content from about 0.1 to about 1.5 pph rubber; a resin content from about 10 to about 24 pph rubber; an oil content from about 10 to about 22 pph rubber; a phenol content from about 0.1 to about 3 pph rubber; a zinc 2-mercapto-toluimidazole content from about content from about 0.1 to about 3 pph rubber; a phenylenediamine content from about 0.1 to about 3 pph rubber; a sulfur donor content from about 2 to about 4 pph rubber; an accelerator content from about 1 to about 7 pph rubber; a sulfur content from about 1 to about 2.5 pph rubber; a stearic acid content from about 0.1 to about 3 pph rubber; an activator content from about 5 to about 15 pph rubber; and/or a combination thereof.

In one preferred embodiment, the one or more antioxidants includes a phenolic antioxidant, a peroxide scavenger, an aminic antioxidant, or a combination thereof.

Optionally, an adhesive layer may be included in a printing blanket according to the invention, in order to adhere the compressible layer to the metallic or polymeric printing sleeve.

The printing face according to the invention may advantageously include one or more elastomeric rubbers; one or more additives and/or processing aids; a crosslinking agent; and one or more antioxidants.

In a preferred embodiment, the one or more printing face layer elastomeric rubbers comprises at least one nitrile rubber copolymer having an acrylonitrile content from about 25% to about 41%, preferably from about 35% to about 40%. In this preferred embodiment, the at least one printing face layer nitrile rubber copolymer possesses an average acrylonitrile content from about 36% to about 40%. One preferred printing face layer nitrile rubber copolymer includes butadiene monomers, as well as acrylonitrile monomers, and optionally, but less preferably a few percent of one or more other comonomers. Preferably, the butadiene content of the printing face layer nitrile rubber copolymer is at least about 55%, preferably at least about 59%, more preferably from about 59% to about 61%. The printing face layer elastomeric rubber may contain a mixture of rubber homopolymers or copolymers containing acrylonitrile monomers, and preferably contains at least about 50%, more preferably at least about 80%, most preferably at least about 90%, of the acrylonitrile-butadiene copolymer.

In one embodiment, the printing face layer elastomeric rubber component comprises a mixture of nitrile rubbers. In another embodiment, the acrylonitrile content of the at least one printing face layer nitrile rubber copolymer can be from about 30% to about 37%, or the average acrylonitrile content of all the included printing face layer nitrile rubber copolymers can be from about 33% to about 37%. In still another embodiment, the one or more printing face layer elastomeric rubbers does not include a polysulfide.

In addition to about 100 parts rubber, a printing face layer composition according to the invention may preferably comprise: crosslinking agents present in an amount from about 5 to about 35 pph rubber, preferably from about 8 to about 25 pph rubber, more preferably from about 10 to about 20 pph rubber; one or more antioxidants present in an amount not more than about 15 pph rubber, preferably from about 0.5 to about 10 pph rubber, more preferably from about 1 to about 8 pph rubber; and additives and/or processing aids present in an amount not more than about 120 pph rubber, preferably from about 20 to about 110 pph rubber, more preferably from about 40 to about 100 pph rubber, most preferably from about 55 to about 95 pph rubber.

In these preferred embodiments, the printing face layer composition according to the present invention may possess one or more of the following: a silica content from about 12 to about 30 pph rubber; a retarding agent content from about 0.5 to about 4 pph rubber; a resin content from about 2 to about 10 pph rubber; a non-vulcanized oil content from about 10 to about 30 pph rubber; a factice content from about 10 to about 30 pph rubber; an organosilane content from about 1 to about 5 pph rubber; a pigment content from about 5 to about 25 pph rubber; a hydroquinoline content from about 0.1 to about 3 pph rubber; a zinc 2-mercapto-toluimidazole content from about content from about 0.1 to about 3 pph rubber; a phenylenediamine content from about 0.5 to about 3 pph rubber; a sulfur donor content from about 1 to about 4 pph rubber; an accelerator content from about 0.1 to about 3 pph rubber; a sulfur content from about 0.5 to about 3 pph rubber; a stearic acid content from about 0.5 to about 4 pph rubber; an activator content from about 5 to about 15 pph rubber; and/or a combination thereof.

In other embodiments, a printing face layer composition according to the present invention may comprise: crosslinking agents present in an amount from about 5 to about 35 pph rubber, preferably from about 8 to about 25 pph rubber, more preferably from about 8 to about 20 pph rubber; one or more antioxidants present in an amount not more than about 10 pph rubber, preferably from about 0.1 to about 5 pph rubber, more preferably from about 0.5 to about 3 pph rubber; and additives and/or processing aids present in an amount not more than about 85 pph rubber, preferably from about 15 to about 75 pph rubber, more preferably from about 25 to about 70 pph rubber, most preferably from about 30 to about 65 pph rubber.

In these other embodiments, the printing face layer composition according to the present invention may preferably possess one or more of the following: from about 20 to about 40 parts of a polysulfide component; from about 5 to about 20 pph of silica; from about 10 to about 30 pph of a factice; from about 0.1 to about 5 pph of a phenolic antioxidant; from about 3 to about 12 pph of pigment; from about 1 to about 10 pph of an accelerator; from about 4 to about 10 pph of a non-vulcanized oil; from about 0.1 to 1.5 pph of a retarding agent; from about 0.1 to 3 pph of stearic acid; from about 3 to about 15 pph of an activator; and/or a combination thereof.

In another preferred embodiment, the one or more printing face layer additives and/or processing aids includes a factice, at least one pigment, a retarding agent, an inorganic filler, or a combination thereof.

When present, the adhesive layer composition according to the invention may advantageously include about 100 parts of one or more elastomeric rubbers; one or more additives and/or processing aids; a crosslinking agent; and one or more antioxidants.

In a preferred embodiment, the one or more adhesive layer elastomeric rubbers comprises at least one nitrile rubber copolymer having an acrylonitrile content from about 25% to about 41%, preferably from about 30% to about 35%. In this preferred embodiment, the at least one adhesive layer nitrile rubber copolymer possesses an average acrylonitrile content from about 30% to about 35%. One preferred adhesive layer nitrile rubber copolymer includes butadiene monomers, as well as acrylonitrile monomers, and optionally, but less preferably a few percent of one or more other comonomers. Preferably, the butadiene content of the adhesive layer nitrile rubber copolymer is at least about 60%, preferably at least about 65%, more preferably from about 66% to about 68%. The adhesive layer elastomeric rubber may contain a mixture of rubber homopolymers or copolymers containing acrylonitrile monomers, and preferably contains at least about 50%, more preferably at least about 80%, most preferably at least about 90%, of the acrylonitrile-butadiene copolymer.

In addition to about 100 parts rubber, an adhesive layer composition according to the present invention may preferably comprise: crosslinking agents present in an amount from about 2 to about 30 pph rubber, preferably from about 4 to about 25 pph rubber, more preferably from about 6 to about 20 pph rubber; one or more antioxidants present in an amount not more than about 10 pph rubber, preferably from about 0.1 to about 8 pph rubber, more preferably from about 0.5 to about 6 pph rubber; and additives and/or processing aids present in an amount not more than about 95 pph rubber, preferably from about 15 to about 90 pph rubber, more preferably from about 25 to about 85 pph rubber, most preferably from about 35 to about 80 pph rubber.

In preferred embodiments, the adhesive layer composition according to the present invention may possess one or more of the following: a silica content from about 20 to about 55 pph rubber; a non-vulcanized oil content from about 10 to about 30 pph rubber; an organosilane content from about 0.5 to about 3 pph rubber; a pigment content from about 3 to about 20 pph rubber; a bis-phenol content from about 0.5 to about 6 pph rubber; an accelerator content from about 1 to about 10 pph rubber; a sulfur content from about 0.5 to about 4 pph rubber; an activator content from about 2 to about 12 pph rubber; and/or a combination thereof.

In one embodiment, an adhesive layer according to the invention is disposed between the printing face and the compressible layer. In another embodiment, an adhesive layer according to the invention is disposed between the printing face and a reinforcing layer. In still another embodiment, an adhesive layer according to the invention is disposed between a reinforcing layer and the compressible layer. In any of these embodiments, the adhesive layer may advantageously function as an adhesive or compatibilizer for the two layers between which it is disposed.

In a preferred embodiment, the one or more adhesive layer elastomeric rubbers comprises at least one nitrile rubber copolymer having an acrylonitrile content from about 25% to about 41%, preferably from about 30% to about 37%. In this preferred embodiment, the at least one adhesive layer nitrile rubber copolymer possesses an average acrylonitrile content from about 30% to about 37%.

In one preferred embodiment, the polymeric sleeve contains substantially no threading. In another preferred embodiment, each layer of the printing blanket according to the invention contains substantially no threading. As used herein, “substantially no” should be understood to mean not more than about 2% by weight, preferably not more than about 1% by weight, more preferably not more than about 0.1% by weight, most preferably absolutely no, threading.

In certain cases, one or more of the layers of the printing blanket may be at least partially formed by electrostatic spray coating. It is known that electrostatic spraying involves movement of charged particles, and therefore forms a small but non-zero current. Therefore, the blanket substrate must be at least partially conductive. In one embodiment, if the sleeve is not metal, the sleeve has incorporated therein or thereon conductive fibers, for example carbon fiber, or minerals, for example silicates, aluminosilicates, or the like, to help distribute the electrostatic charge more evenly about the sleeve. In flat blankets that typically have a fabric substrate, or in cylindrical blankets made of flat preformed components sprayed on for example a film ribbon or a film intended to be wrapped about a sleeve, it is often advantageous to incorporate conductive fibers or minerals within or disposed near to the fabric substrate or film. Of course, the blanket fabric substrate or film may in a less preferred method may be placed against a conductive backing.

### EXAMPLES

### Example 1

### Compressible Layer Composition For Use in a Printing Blanket According to the Invention

The composition of the compressible layer of Example 1 is delineated in the table below. NIPOL DN1201 is a terpolymer containing about 35% acrylonitrile, about 33% butadiene, and about 32% isoprene.

| | EXAMPLE 1 | COMPONENT RANGES |
|---|---|---|
| COMPONENT | (PPH RUBBER) | (PPH RUBBER) |
| NIPOL DN1201 nitrile rubber | 100 | About 100 parts rubber |
| N550 Carbon black | 20 | From about 10 to about 40 |
| EXPANCEL microspheres | 5.5 | From about 1 to about 10 |
| Phthalimide | 0.5 | Not more than about 2 |
| FF Wood Resin | 8 | From about 2 to about 14 |
| SUNDEX 790 aromatic oil | 16 | From about 2 to about 25 |
| P-87 phenol formaldehyde resin | 7 | From about 1 to about 15 |
| Phenol | 1 | Not more than about 3 |
| Zinc 2-mercapto-toluimidazole | 1 | Not more than about 3 |
| Phenylenediamine | 1 | Not more than about 3 |
| Dithiodimorpholine | 3 | From about 1 to about 5 |
| BUTYL-8 carbamide compound | 2 | From about 0.5 to about 5 |
| Tetraethylthiuram | 2 | From about 0.25 to about 4 |
| Spider Sulfur | 1.5 | From about 0.25 to about 2.5 |
| Stearic Acid | 1 | Not more than about 4 |
| Zinc Oxide (85%, KENRICH French Process) | 9 | From about 2.5 to about 40 |

The ingredients above were combined using a BANBURY mixer. Temperature, mixing strength, and order of addition of ingredients was controlled so that the composition was homogenized but such that there was substantially no interference with fabrication of the compressible layer via premature activation of the crosslinking or vulcanization reaction. Once the compressible layer composition of Example 1 was sufficiently mixed, a sufficient amount of an organic solvent, e.g., toluene, was added to the resultant mixture in order to facilitate deposition on, and compatibilization with, the substrate upon which the compressible layer composition was deposited (i.e., a metallic or polymeric sleeve).

The compressible layer composition of Example 1, as fabricated, exhibited a Shore A hardness of approximately 54.

Printing blankets were also fabricated incorporating the compressible layer of Example 1, as described above. A reinforcing layer, comprising the above composition without the microspheres can be disposed above or below the compressible layer of Example 1.

### Example 2

### Printing Face Composition For Use in a Printing Blanket According to the Invention.

The composition of the printing face layer of Example 2 is delineated in the table below. The NIPOL VT rubbers are copolymers of acrylonitrile and butadiene, each having a Mooney viscosity of approximately 80. The composition of the 380 rubber is approximately 30/70 acrylonitrile/butadiene; the composition of the 480 rubber is approximately 40/60 acrylonitrile/butadiene; and the composition of the 3380 rubber is approximately 33/67 acrylonitrile/butadiene.

| INGREDIENT | INDIVIDUAL COMPONENTS |
|---|---|
| NIPOL VT380 nitrile rubber | From about 10 to about 20 parts |
| NIPOL VT480 nitrile rubber | From about 10 to about 20 parts |
| NIPOL DN3380 nitrile rubber | From about 25 to about 50 parts |
| THIOKOL Polysulfide | From about 15 to about 45 parts |
| HISIL 233 silica | From about 2 to about 30 parts |
| RHENOPRENE C crosslinked | From about 5 to about 40 parts |
| vegetable oil | |
| Stearic Acid | Not more than about 5 parts |
| NAUGAWHITE bis-phenol | Not more than about 10 parts |
| RHENOGRAN ZNO-85 (85% ZnO IN | From about 1 to about 20 parts |
| EPR) | |
| Phthalimide | Not more than about 2 parts |
| POLY-DISPERSION A(TI)D-80 (80% | Not more than about 10 parts |
| TIO2 IN NBR) | |
| 12973 Blue pigment | From about 0.5 to about 10 parts |
| RHENOGRAN MBTS-75 (75% | From about 0.5 to about 10 parts |
| sulfenamide IN EPR) | |
| tetramethylthiuram | From about 0.5 to about 5 parts |
| di(butoxy-ethoxy-ethyl)formal oil | From about 2 to about 15 parts |

The ingredients above were combined using a BANBURY mixer. Temperature, mixing strength, and order of addition of ingredients was controlled so that the composition was homogenized but such that there was substantially no interference with fabrication of the compressible layer via premature activation of the crosslinking or vulcanization reaction.

Printing blankets were also fabricated incorporating the printing face layer of Example 2. This was accomplished by extruding the composition and disposing the composition over a compressible layer, or optionally over an adhesive layer that is disposed upon a reinforcing layer and/or the compressible layer.

### Example 3

### Printing Face Composition For Use in a Printing Blanket According to the Invention.

The composition of the printing face layer of Example 3 is delineated in the table below. NIPOL 4050 is a copolymer containing approximately 40% acrylonitrile and about 60% butadiene.

| | EXAMPLE 3 | COMPONENT RANGES |
|---|---|---|
| INGREDIENT | (PPH RUBBER) | (PPH RUBBER) |
| NIPOL 4050 nitrile rubber | 100 | About 100 parts |
| DURASIL 880 Silica | 20 | From about 5 to about 50 |
| DEGUSSA SI-69 organosilane | 3 | From about 0.5 to about 6 |
| AKROCHEM P-87 phenol formaldehyde resin | 5 | From about 2 to about 10 |
| RHENOPRENE EPS crosslinked vegetable oil | 20 | From about 5 to about 40 |
| PLASTHALL P-900 polyester phthalate oil | 20 | From about 5 to about 35 |
| MAGLITE K (magnesium oxide) | 3 | Not more than about 10 |
| AKROCHEM DQ (hydroquinoline) | 1 | Not more than about 5 |
| VANOX ZMTI (zinc 2-mercapto-toluimidazole) | 1 | Not more than about 5 |
| HARWICK 12973 Blue pigment | 4 | From about 0.5 to about 10 |
| POLYMERICS 80% TiO2 White pigment | 10 | From about 2 to about 25 |
| Phenylenediamine | 2 | Not more than about 5 |
| Dithiodimorpholine | 2 | From about 1 to about 5 |
| Tetraethylthiuram | 0.5 | From about 0.25 to about 4 |
| Pthalimide | 2 | Not more than about 2 |
| AKROCHEM P-80 sulfur (80% sulfur in SBR) | 1.5 | From about 0.5 to about 3 |
| Stearic Acid | 2 | From about 0.5 to about 4 |
| Zinc Oxide (85% KENRICH French Process) | 5 | From about 2.5 to about 40 |

The ingredients above were combined using a BANBURY mixer. Temperature, mixing strength, and order of addition of ingredients was controlled so that the composition was homogenized but such that there was substantially no interference with fabrication of the compressible layer via premature activation of the crosslinking or vulcanization reaction.

Increased hydrophilicity can be advantageous in printing faces of the invention. The printing face of Example 3 shows more hydrophilic character than the printing face described in Example 2. Without being bound to theory, it is surmised that the addition of the polyester phthalate oil and the magnesium oxide co-accelerator result in the increased hydrophilicity of the composition in Example 3.

Printing blankets were also fabricated incorporating the printing face layer of Example 3. Similarly to that described in Example 2, this was accomplished by extruding the composition and disposing the composition over a compressible layer, or optionally over an adhesive layer that is disposed upon a reinforcing layer and/or the compressible layer.

### Example 4

### Adhesive Layer Composition For Use in a Printing Blanket According to the Invention

The composition of the adhesive layer of Example 4 is delineated in the table below. PARACRIL BJLT M-50 is a 33/67 copolymer of acrylonitrile and butadiene.

| | EXAMPLE 4 | COMPONENT RANGES |
|---|---|---|
| INGREDIENT | (PPH RUBBER) | (PPH RUBBER) |
| PARACRIL BJLT M-50 nitrile rubber | 100 | About 100 parts |
| HISIL 233 silica | 40 | From about 5 to about 50 |
| DEGUSSA SI-69 organosilane | 0.8 | From about 0.5 to about 3 |
| CARBOWAX 3350 polyethylene glycol | 3 | From about 0.5 to about 6 |
| NAUGAWHITEa bis-phenol | 2 | Not more than about 10 |
| HARWICK 12973 Blue pigment | 3.5 | From about 0.5 to about 10 |
| DuPont R-900 (RUTILE) titanium dioxide | 5 | From about 1 to about 20 |
| PALANTIOL 711P mixed 7—11 phthalate oil | 15 | From about 5 to about 40 |
| RHENOGRAN ZN0-85 (85% ZnO IN EPR) | 3 | From about 0.5 to about 10 |
| Tetraethylthiuram | 0.5 | From about 0.1 to about 3 |
| RHENOGRAN TBBS-75 (75% sulfenamide IN | 2 | From about 0.5 to about 10 |
| EPR) | | |
| AKROCHEM P-80 sulfur (80% sulfur in SBR) | 2 | From about 0.5 to about 10 |

The ingredients above were combined using a BANBURY mixer. Temperature, mixing strength, and order of addition of ingredients was controlled so that the composition was homogenized but such that there was substantially no interference with fabrication of the compressible layer via premature activation of the crosslinking or vulcanization reaction. Once the adhesive layer composition of Example 4 was sufficiently mixed, a sufficient amount of an organic solvent, e.g., toluene, was added to the resultant mixture in order to facilitate deposition on, and compatibilization with, the compressible layer.

Printing blankets were also fabricated incorporating the adhesive layer of Example 4. This was accomplished by depositing a thin layer of the mixed composition, including the solvent (e.g., from about 0.1 to about 5 mils thick, preferably from about 0.5 to about 3 mils thick) onto the vulcanized or partially vulcanized compressible layer (e.g., usually one that has already been deposited on a substrate printing sleeve) or onto a reinforcing layer disposed upon the compressible layer. This layer may serve as an adhesive, or at least as a compatibilizing layer, between the compressible layer or a reinforcing layer and a printing face deposited upon the adhesive layer. Alternately, the layer may serve as an adhesive, or at least as a compatibilizing layer, between the compressible layer and a reinforcing layer deposited upon the adhesive layer. The adhesive layer may be especially useful in adhering a vulcanized or partially vulcanized layer to an unvulcanized layer.

### Example 5

### Tests of Printing Blanket According to the Invention

In the printing industry that there are many factors that enter into the utility of a printing blanket. In addition to the basic properties of the layers, the blanket must have the appropriate acidity and wettability, the required stiffness but also the required compressibility, and the layer formulations must not creep or show signs of age while in operation. During typical operation, a blanket is expanded and placed on a roller, rotated at a high velocity while being coated with different ink formulations while compressing against both paper and other rollers, nips, and the like, and must be able to survive impacts when multiple pieces of printing substrate, i.e., paper, are accidently jammed in the small tolerances between the blanket and the roller. As a result, no printing blanket formulations can be considered useful unless they have been tested on a printer. Printing blankets using the formulations of Example 1 for the compressible layer, Example 4 for the adhesive, and either Example 2 or Example 3, were prepared using electrostatic-spray-on technology. These sleeves have no threads, and are manufactured by

providing a primed nickel sleeve;

electrostatic spraying on the compressible layer onto the nickel sleeve;

at least partially vulcanizing the compressible layer;

optionally grinding the compressible layer;

applying the adhesive over at least partially vulcanized compressible layer;

electrostatic spraying of the printing face formulary of either example 2 or example 3;

vulcanizing the rubbers in the sleeve; and

grinding the printing face to a tolerance of about 1 micron.

The tests were Four-Color Catalogs printed on a SUNDAY PRESS™ available from Heidelberger Druckmaschinen A G, Heidelberg, D E. A four color test is a rigorous test as multiple rollers must act in concert to provide acceptable registration as the printing substrate passes from one roller to the next. In these tests, there was no Process Color in Unit #1, Black was in Unit #2. A print run was started with commercially available sleeves which were run for about 350,000 impressions. The print operating data from the prior art commercial sleeves is shown in Table 1.

TABLE 1

Temperature

| | Unit | Compliancy | Oper. | Gear |
|---|---|---|---|---|
| Com. 1 | #2 - Upper Black | 42 | 90 | 92 |
| Com. 2 | #2 - Lower Black | 42 | 95 | 92 |
| Com. 3 | #3 - Upper Cyan | 40 | 95 | 96 |
| Com. 4 | #3 - Lower Cyan | 40 | 95 | 96 |
| Com. 5 | #4 - Up. Magenta | 41 | 95 | 97 |
| Com. 6 | #4 - Lo. Magenta | 41 | 96 | 99 |
| Com. 7 | #5 - Upper Yellow | 43 | 98 | 97 |
| Com. 8 | #5 - Lower Yellow | 43 | 98 | 99 |

The sleeves of this invention, which contained no threads and the printing face formulary of Example 2, were then installed. Printing was within 0.002″ on register and color looked good, and after warmup of about 2,000 sheets the print was of commercial quality.

The water was reduced, and the print quality improved marginally. These sleeves were consumed after 1-1.5 million impressions.

In the next test, the sleeves were gradually replaced with the printing face formulary of Example 3, of this invention. A second catalog was printed, again with 4 colors. The color was of commercial quality, but after about 400,000 impressions three of the sleeves were pulled. Two had pinholes or blisters and one had ink piling.

These three sleeves were replaced with the sleeves of Example 3. Ultimately, one was on the black unit and two were on the Magenta unit. The register and color were fine and no noticeable difference was observed by the Press Crew. The sleeves ran 0.9 million impressions.

The printing face formulary of Example 2 has a tensile strength less than 1000 psi. The tensile strength of the printing face formulary of Example 3 exhibits greater than 1000 psi but less than 6000 psi tensile values.

All experimental sleeves went on easily, without need of lubricant. The tests were run at 1400 to 2700 feet per hour, and 14000-88000 impressions per hour. Table 2 describes the print operating data for the Sleeves with printing face formulary of Example 2 that replaced the commercial sleeves listed above, when run at 2400 feet per hour and 78000 impressions per hour, where Id. is an identification number.

TABLE 2

Temperature

| I.D. | Unit | Oper. | Gear |
|---|---|---|---|
| 6044 | #2 —Upper Black | 98 | 99 |
| 6670 | #2 - Lower Black | 97 | 100 |
| 9432 | #3 - Lower Cyan | 101 | 100 |
| 9410 | #3 - Upper Cyan | 99 | 97 |
| 6835 | #4 - Lower Magenta | 102 | 98 |
| 9436 | #4 - Upper Magenta | 103 | 100 |
| 4447 | #5 - Upper Yellow | 100 | 101 |
| 6675 | #5 - Lower Yellow | 102 | 101 |

The temperature is recorded because it is desirable to control both gear and operating temperatures within prescribed limits. The blankets must not generate excessive heat during operation, and must be able to dissipate the heat generated.

No bustle wheels were needed and the sheet looked good. The operators mentioned that they have problems printing wide webs >52″ with commercial sleeves, where the registration on the ends varies from the rest of the sleeve on wide webs. At the time this was checked there were 500,000 impressions on the plates and the problem was not observed with the experimental sleeves. The printing was done on 50 weight paper DESPERADO™ Web Paper from Mead. The print job was a Catalog that was 44 ½″ wide.

We have surprisingly found that the thicker compressible layer and the relatively lower compliancy of the composition allow the locust of many points to act as independent springs. On a 57″ long Sleeve, it is estimated that the core deflects between 0.003-0.004″ from the center to the ends during high speed operation. The center deflects more than the ends. In a traditional sleeve of the prior art, to compensate for the deflection, the ends are step ground or profiled. The sleeve of the prior art includes wound inextensible thread layer that require the step grind. The new sleeves of this invention contain no such inextensible layer, that is, the nickel is inextensible but the compressible layer and the face later are 100% elastomeric. Elastomers with a 50-60 Shore A hardness are considered elastic. The compressible layer formulations contain 4.5% & 5.5% by weight microspheres. The range of microspheres can be 1-7% with the preferred being 2.5-6.0% and most preferred being 5.0-5.5%. Though these sleeves had a profiled grind of a layer, sleeves of this invention in some embodiments have been surprisingly found to not need profile grinding. The following data was obtained with sleeves of at 2407 feet per hour.

| | | Temperature (F) | | |
|---|---|---|---|---|
| Sleeve ID | Unit | Oper. | Gear | Comments |
| 6044 | #2 - Upper Black | 97 | 97 | Job running smooth |
| 6670 | #2 - Lower Black | 98 | 101 | 90,000 impressions |
| 6816 | #3 - Upper Cyan | 97 | 100 | |
| 9432 | #3 - Lower Cyan | 101 | 100 | |
| 9436 | #4 - Upper Magenta | 103 | 101 | |
| 9435 | #4 - Lower Magenta | 103 | 104 | |
| 6675 | #5 - Upper Yellow | 103 | 102 | |
| 4447 | #5 - Lower Yellow | 101 | 103 | |

The speed of the press was increased to 2503 feet per hour (81,000 impressions per hour) and the following temperature data was obtained after 205,000 impressions and after temperature was increased 2 degrees F. and then brought back down after 292,000 net impressions were made.

| | | | | Temperature | |
|---|---|---|---|---|---|
| Sleeve ID | | Temperature | | @ 292,000 | |
| impressions | Unit | Oper. | Gear | Oper. | Gear |
| 6044 | #2 - Upper Black | 100 | 100 | 96 | 96 |
| 6670 | #2 - Lower Black | 103 | 100 | 96 | 97 |
| 6816 | #3 - Upper Cyan | 98 | 101 | 98 | 99 |
| 9432 | #3 - Lower Cyan | 101 | 101 | 99 | 104 |
| 9436 | #4 - Upper Magenta | 105 | 101 | 105 | 100 |
| 9435 | #4 - Lower Magenta | 102 | 104 | 100 | 100 |
| 6675 | #5 - Upper Yellow | 104 | 101 | 104 | 100 |
| 4447 | #5 - Lower Yellow | 101 | 104 | 102 | 103 |

At 379,000 impressions the temperature remained fairly stable, and washup was easy. At 500,000 impressions the #2—Upper Black sleeve blew out, and shortly thereafter the #4—Upper Magenta and #4—Lower Magenta sleeves were replaced due to pin holes. The sleeves reached 125 degrees F. after removal from the press. There was a slight registration problem after these sleeves were replaced with EXP-350 sleeves with the printing face formulary of Example 3, but the quality was soon commercially acceptable. The operating temperature at 2100 feet per hour (68,000 impressions per hour) were:

Temperature

| Sleeve ID | Unit | Oper. | Gear |
|---|---|---|---|
| 9441 | #2 - Upper Black | 92 | 91 |
| 6670 | #2 - Lower Black | 93 | 94 |
| 6810 | #3 - Upper Cyan | 95 | 97 |
| 9432 | #3 - Lower Cyan | 95 | 98 |
| 157 EXP-350 | #4 - Upper Magenta | 99 | 96 |
| 021 EXP-350 | #4 - Lower Magenta | 96 | 97 |
| 6675 | #5 - UpperYellow | 100 | 97 |
| 4447 | #5 - Lower Yellow | 96 | 100 |

With these sleeves in place a new 4-color Catalog job was started using a 38# paper Drapers Gloss™ and a 46 ¼″ wide web. The 9441 sleeve was damaged during transition and was replaced. Operating conditions were:

| | | Temperature | |
|---|---|---|---|
| Sleeve ID | Unit | Oper. | Gear |
| 9443 | #2 - Upper Black | 105 | 96 |
| 6670 | #2 - Lower Black | 109 | 106 |
| 6810 | #3 - Upper Cyan | 106 | 105 |
| 9432 | #3 - Lower Cyan | 112 | 105 |
| 157-EXP-350 | #4 - Upper Magenta | 110 | 106 |
| 021-EXP-350 | #4 - Lower Magenta | 96 | 95 |
| 6675 | #5 - Upper Yellow | 95 | 94 |
| 4447 | #5 - Lower Yellow | 91 | 95 |

At 247,000 impressions, the unit continued to run without problems, and operating temperatures were between 93 degrees F. and 101 degrees F., generally increasing as the unit increased. The #4—Lower Magenta gear was running at 103 degrees F., about 4 degrees hotter than the operating temperature. The remaining gear temperatures were within 2 degrees F. of the operating temperatures. Soon thereafter, several sleeves blistered and were replaced.

About 2,000,000 impressions were accumulated on the sleeves of Example 3 and on the other sleeves of this invention. The print was judged to be of commercial quality and the electrostatically sprayed, no-thread sleeves of this invention were interchangeable with commercial threaded blankets.

The printing blankets with the elastomeric compositions described above and in the claims are considerably stronger than the prior art blankets. As such, the strength of wound threads which were used in the prior art to apply the compressible layer and often the printing layer, is not needed. The threads provided a substantially inelastic layer. The modulus of elasticity can be made high enough such that a reinforcing layer of threads is not needed. A preferred embodiment comprises at least one layer that has a modulus of elasticity that is between about 100 pounds per square inch and 2000 pounds per square inch, preferably between about 500 pounds per square inch and about 950 pounds per square inch, more preferably between about 700 pounds per square inch and about 900 pounds per square inch. Preferably, this layer is between about 0.006 inches and 0.047 inches in thickness. This provides strength while not giving a layer that is substantially inelastic. Inelastic layers incorporated into a cylindrical printing blanket may be responsibe for standing waves being forms at the entrance where the blanket contacts a roller.

In another embodiment, a reinforcing layer can be disposed between the compressible layer and the printing face layer. This layer may be of an elastomer composition of the printing face layer or of the compressible face layer, but with added crosslinking agents, for example up to twice the curing and crosslinking agents specified for the printing face layer or of the compressible face layer, respectively.

In another embodiment, a reinforcing layer can be a film with a modulus of elasticity of between about 1000 pounds per square inch and about 20000 pounds per square inch, preferably between about 11000 pounds per square inch and about 16000 pounds per square inch. High strength ribbons of this low elasticity film can be wound in a barber pole fashion around the printing blanket, and can be adhered to the sleeve and/or to the elastomeric layer(s) by for example an adhesive described herein. An elastomeric product may already be put on the substantially inelastic film prior to winding the film onto the substrate. This elastomeric product, preferably a printing face formulation or a compressible layer formulation with or without microcells, may be in a cured state, a partially cured but tacky state, or a substantially uncured state which may include residual solvents. The elastomeric material is beneficially facing outward so that any subsequent grinding will not affect the integrity of the film. A preferred film comprises at least one of MYLAR (™), ARAMID™, KEVLAR™, high density polyethylene, polyester, or other film-forming polymers with high modulus/low elongation properties known in the art.

The preferred polymeric sleeve comprises one or more layers of MYLAR. The polymeric sleeve may be made by extrusion, by winding, or by a combination thereof. The polymeric sleeve may have reinforcing materials embedded therein, ir may be self-reinforced by stretching the blanket to partially orient the polymeric molecules. Said stretching can be performed at a temperature above or below the glass transition temperature.

In one embodiment sleeves that were 0.005 inches, 0.010 inches, and 0.020 inches in thickness were tested. The thickness of the polymeric sleeve in one embodiment is between about 0.004 inches and 0.28 inches, preferably between about 0.1 inches and 0.20 inches. The use of the higher strength polymeric materials described herein, which optionally includes a reinforcing layer, provides sufficient strength to the blanket that these thinner polymeric sleeves can be used.

The inner layer, the outer layer, or both of the sleeve may be treated to increase friction, reduce squealing noise, or increase adherence of other layers.

We claim:

1. A cylindrical printing blanket comprising an inner multilayer spiral wound polymeric sleeve, wherein the sleeve comprises between 2 and 5 layers that are affixed to one another with a first adhesive, the winds overlay one another to form the multiple layers, the gap between adjacent edges of the ribbon are less than 0.2 inches apart as measured axially, the total sleeve thickness is between 0.006 to 0.0028 inches, and the layers are formed from a single continuous ribbon of polymeric material.

2. The printing blanket of claim 1 wherein the gap between adjacent edges of the ribbon is less than about 0.1 inches.

3. The printing blanket of claim 1 wherein the gap between adjacent edges of the ribbon is less than about 0.05 inches.

4. The printing blanket of claim 1 wherein the sleeve has 2 or 3 layers, and the total sleeve thickness is between 0.009 to about 0.024 inches.

5. The printing blanket of claim 1 wherein the total sleeve thickness is between 0.015 to about 0.021 inches.

6. The printing blanket of claim 1 wherein the polymeric sleeve comprises nylon, aramid, polyester, high density linear polyethylene, or mylar.

7. The printing blanket of claim 1 wherein the first adhesive comprises a thermoplastic adhesive with a melt temperature greater than about 300° F.

8. The printing blanket of claim 1 wherein the first adhesive comprises a thermoset adhesive.

9. The printing blanket of claim 8 wherein the first adhesive comprises a two-component urethane adhesive.

10. A printing blanket comprising an inner multilayer spiral wound polymeric sleeve, wherein the sleeve comprises between 2 and 5 layers that are affixed to one another with a first adhesive, the winds overlay one another to form the multiple layers, the gap between adjacent edges of each ribbon are less than 0.2 inches apart as measured axially, the total sleeve thickness is between 0.006 to 0.0028 inches, and the layers are formed from a plurality of continuous ribbons of polymeric material.

11. The printing blanket of claim 10 wherein the sleeve has 2 or 3 layers, and the total sleeve thickness is between 0.009 to about 0.024 inches, and at least one layer is formed of a different polymer than another layer.

12. The printing blanket of claim 10 wherein the edges of at least one of the ribbons abut one another.

13. A cylindrical printing blanket comprising an inner multilayer spiral wound polymeric sleeve, wherein the sleeve comprises between 2 and 5 layers that are affixed to one another with a first adhesive, the winds overlay one another to form the multiple layers, the adjacent edges of the ribbon overlay axially in an amount such that relaxation during curing results in non-overlapping edges, the total sleeve thickness is between 0.006 to 0.0028 inches, and the layers are formed from a single continuous ribbon of polymeric material.

14. A printing blanket comprising:
a multilayer spiral wound polymeric sleeve comprising between 2 and 5 layers that are affixed to one another with a first adhesive, in which sleeve the winds overlay one another to form the multiple layers and in which sleeve the adjacent edges of the ribbon overlay axially in an amount such that relaxation during curing results in non-overlapping edges, wherein the total sleeve thickness is between 0.006 to 0.0028 inches, and wherein the layers are formed from a single continuous ribbon of polymeric material or from a plurality of continuous ribbons of polymeric material;
a compressible layer including a open or closed-cell polymeric foam;
optionally, a reinforcing layer;
optionally, at least one second adhesive layer; and
a printing face layer.

15. The printing blanket of claim 14, wherein the compressible layer comprises:
about 100 parts of an acrylonitrile-containing copolymer rubber;
microspheres present in an amount from about 1 to about 10 pph rubber;
a particulate filler present in an amount from about 10 to about 40 pph rubber;
a retarding agent present in an amount of not more than about 2 pph rubber;
one or more resins present in an amount from about 3 to about 29 pph rubber;
a non-crosslinked oil present in an amount from about 2 to about 25 pph rubber;
one or more antioxidants present in an amount not more than about 9 pph rubber;
one or more accelerators present in an amount from about 2 to about 14 pph rubber;
one or more activators present in an amount from about 2.5 to about 40 pph rubber;
a sulfur source present in an amount from about 0.25 to about 2.5 pph rubber; and
an acidic dispersant present in an amount of not more than about 4 pph rubber,
and wherein the compressible layer composition is vulcanized to form the compressible layer and is disposed over the polymeric sleeve.

16. The printing blanket of claim 14, wherein the printing face comprises:
a base of 100 parts of nitrile with between about 35% to about 50% by weight acrylonitrile content copolymerized with butadiene;
about 5 to about 50 pph of silica;
about 0.1 to about 15 pph of a coupling agent;
about 5 to about 60 pph of a processing oil;
at least about 0.1 pph of a sulfur-based curing agent;
about 1 to about 10 pph zinc oxide; and
about 1 to about 20 pph metal oxide, wherein the metal oxide comprises TiO₂, MgO, CaO, or a mixture thereof.

17. The printing blanket of claim 14, wherein the printing face comprises:
about 100 parts of nitrile rubber with an average acrylonitrile content from about 36% to about 40% by weight;
from about 5 to about 50 parts silica;
from about 0.5 to about 6 of an organosilane;
from about 2 to about 10 parts of a tackifying resin;
from about 5 to about 40 parts of a crosslinked vegetable oil
from about 5 to about 35 parts of a hydrophillic polymer;
from about 2.5 to about 30 parts of a metal oxide;
from about 0.5 to about 4 parts of a fatty acid; and
from about 0.5 to about 3 parts sulfur.

18. The printing blanket of claim 17, wherein the blanket is substantially free of polysulfide polymer, and wherein the printing face layer possesses a tensile strength of greater than 1000 pounds per square inch.

19. The printing blanket of claim 14, wherein the second adhesive layer comprises:
about 100 parts of at least one nitrile rubber copolymer having an acrylonitrile content from about 25% to about 41%
a particulate filler content from about 5 to about 50 pph rubber;
a non-vulcanized oil content from about 5 to about 40 pph rubber;
an organosilane content from about 0.5 to about 3 pph rubber;
a pigment content from about 1.5 to about 30 pph rubber;
an antioxidant content from about 0.5 to about 6 pph rubber;
an accelerator content from about 0.6 to about 13 pph rubber;
a sulfur content from about 0.5 to about 10 pph rubber;
an activator content from about 1 to about 16 pph rubber; or
a combination thereof,
and wherein the at least one second adhesive layer is disposed between the compressible layer and the printing face layer, or wherein the at least one second adhesive layer is disposed between the polymeric sleeve and the compressible layer.

20. The printing blanket of claim 14, wherein the reinforcing layer comprises:
about 100 parts of an acrylonitrile-containing copolymer rubber;
a particulate filler present in an amount from about 10 to about 40 pph rubber;
a retarding agent present in an amount of not more than about 2 pph rubber;
one or more resins present in an amount from about 3 to about 29 pph rubber;
a non-crosslinked oil present in an amount from about 2 to about 25 pph rubber;
one or more antioxidants present in an amount not more than about 9 pph rubber;
one or more accelerators present in an amount from about 2 to about 14 pph rubber;
one or more activators present in an amount from about 2.5 to about 40 pph rubber;
a sulfur source present in an amount from about 0.25 to about 2.5 pph rubber; and
an acidic dispersant present in an amount of not more than about 4 pph rubber,
and wherein the reinforcing layer composition is vulcanized to form the reinforcing layer and is disposed over the compressible layer and below the printing face layer.

21. The printing blanket of claim 20, wherein the at least one second adhesive layer comprises:
about 100 parts of at least one nitrile rubber copolymer having an acrylonitrile content from about 25% to about 41%
a particulate filler content from about 5 to about 50 pph rubber;
a non-vulcanized oil content from about 5 to about 40 pph rubber;
an organosilane content from about 0.5 to about 3 pph rubber;
a pigment content from about 1.5 to about 30 pph rubber;
an antioxidant content from about 0.5 to about 6 pph rubber;
an accelerator content from about 0.6 to about 13 pph rubber;
a sulfur content from about 0.5 to about 10 pph rubber;
an activator content from about 1 to about 16 pph rubber; or
a combination thereof,
and wherein the at least one second adhesive layer is disposed between the compressible layer and the reinforcing layer, or wherein the at least one second adhesive layer is disposed between the reinforcing layer and the printing face layer.

22. A printing blanket comprising:
a multilayer spiral wound polymeric sleeve comprising between 2 and 5 layers that are affixed to one another with a first adhesive, in which sleeve the winds overlay one another to form the multiple layers and in which sleeve the winds overlay one another to form the multiple layers, wherein the total sleeve thickness is between 0.006 to 0.0028 inches, and wherein the layers are formed from a single continuous ribbon of polymeric material or from a plurality of continuous ribbons of polymeric material;
a compressible layer including a open or closed-cell polymeric foam;
optionally, a reinforcing layer;
optionally, at least one second adhesive layer; and
a printing face layer.

23. The printing blanket of claim 22, wherein the compressible layer comprises:
about 100 parts of an acrylonitrile-containing copolymer rubber;
microspheres present in an amount from about 1 to about 10 pph rubber;
a particulate filler present in an amount from about 10 to about 40 pph rubber;
a retarding agent present in an amount of not more than about 2 pph rubber;
one or more resins present in an amount from about 3 to about 29 pph rubber;
a non-crosslinked oil present in an amount from about 2 to about 25 pph rubber;
one or more antioxidants present in an amount not more than about 9 pph rubber;
one or more accelerators present in an amount from about 2 to about 14 pph rubber;
one or more activators present in an amount from about 2.5 to about 40 pph rubber;
a sulfur source present in an amount from about 0.25 to about 2.5 pph rubber; and
an acidic dispersant present in an amount of not more than about 4 pph rubber,
and wherein the compressible layer composition is vulcanized to form the compressible layer and is disposed over the polymeric sleeve.

24. The printing blanket of claim 22, wherein the printing face comprises:
a base of 100 parts of nitrile with between about 35% to about 50% by weight acrylonitrile content copolymerized with butadiene;
about 5 to about 50 pph of silica;
about 0.1 to about 15 pph of a coupling agent;
about 5 to about 60 pph of a processing oil;
at least about 0.1 pph of a sulfur-based curing agent;
about 1 to about 10 pph zinc oxide; and
about 1 to about 20 pph metal oxide, wherein the metal oxide comprises TiO₂, MgO, CaO, or a mixture thereof.

25. The printing blanket of claim 22, wherein the printing face comprises:
about 100 parts of nitrile rubber with an average acrylonitrile content from about 36% to about 40% by weight;
from about 5 to about 50 parts silica;
from about 0.5 to about 6 of an organosilane;
from about 2 to about 10 parts of a tackifying resin;
from about 5 to about 40 parts of a crosslinked vegetable oil
from about 5 to about 35 parts of a hydrophillic polymer;
from about 2.5 to about 30 parts of a metal oxide;
from about 0.5 to about 4 parts of a fatty acid; and
from about 0.5 to about 3 parts sulfur.

26. The printing blanket of claim 25, wherein the blanket is substantially free of polysulfide polymer, and wherein the printing face layer possesses a tensile strength of greater than 1000 pounds per square inch.

27. The printing blanket of claim 22, wherein the at least one second adhesive layer comprises:
about 100 parts of at least one nitrile rubber copolymer having an acrylonitrile content from about 25% to about 41%
a particulate filler content from about 5 to about 50 pph rubber;
a non-vulcanized oil content from about 5 to about 40 pph rubber;
an organosilane content from about 0.5 to about 3 pph rubber;
a pigment content from about 1.5 to about 30 pph rubber;
an antioxidant content from about 0.5 to about 6 pph rubber;
an accelerator content from about 0.6 to about 13 pph rubber;
a sulfur content from about 0.5 to about 10 pph rubber;
an activator content from about 1 to about 16 pph rubber; or
a combination thereof,
and wherein the at least one second adhesive layer is disposed between the compressible layer and the printing face layer, or wherein the at least one second adhesive layer is disposed between the polymeric sleeve and the compressible layer.

28. The printing blanket of claim 22, wherein the reinforcing layer comprises:
about 100 parts of an acrylonitrile-containing copolymer rubber;
a particulate filler present in an amount from about 10 to about 40 pph rubber;
a retarding agent present in an amount of not more than about 2 pph rubber;
one or more resins present in an amount from about 3 to about 29 pph rubber;
a non-crosslinked oil present in an amount from about 2 to about 25 pph rubber;
one or more antioxidants present in an amount not more than about 9 pph rubber;
one or more accelerators present in an amount from about 2 to about 14 pph rubber;
one or more activators present in an amount from about 2.5 to about 40 pph rubber;
a sulfur source present in an amount from about 0.25 to about 2.5 pph rubber; and
an acidic dispersant present in an amount of not more than about 4 pph rubber,
and wherein the reinforcing layer composition is vulcanized to form the reinforcing layer and is disposed over the compressible layer and below the printing face layer.

29. The printing blanket of claim 28, wherein the at least one second adhesive layer comprises:
about 100 parts of at least one nitrile rubber copolymer having an acrylonitrile content from about 25% to about 41%
a particulate filler content from about 5 to about 50 pph rubber;
a non-vulcanized oil content from about 5 to about 40 pph rubber;
an organosilane content from about 0.5 to about 3 pph rubber;
a pigment content from about 1.5 to about 30 pph rubber;
an antioxidant content from about 0.5 to about 6 pph rubber;
an accelerator content from about 0.6 to about 13 pph rubber;
a sulfur content from about 0.5 to about 10 pph rubber;
an activator content from about 1 to about 16 pph rubber; or
a combination thereof,
and wherein the at least one second adhesive layer is disposed between the compressible layer and the reinforcing layer, or wherein the at least one second adhesive layer is disposed between the reinforcing layer and the printing face layer.

30. The printing blanket of claim 14, which contains substantially no threading.

31. The printing blanket of claim 22, which contains substantially no threading.
